(19) United States
(12) Patent Application Publication
(10) Pub. No.: US 2023/0162312 A1
(43) Pub. Date: May 25, 2023

(54) PALLET MANAGEMENT SYSTEM FOR MANAGING PALLETS

(71) Applicants: Pascal GYSIN, Sissach (CH); Kai WECKNER, Ilmenau (DE)

(72) Inventors: Pascal GYSIN, Sissach (CH); Kai WECKNER, Ilmenau (DE)

(21) Appl. No.: 17/910,407

(22) PCT Filed: Mar. 11, 2021
(86) PCT No.: PCT/EP2021/056217

§ 371 Date: Sep. 9, 2022

(30) Foreign Application Priority Data
Mar. 12, 2020 (DE) 10 2020 203 207.6

(51) Int. Cl. G06Q 50/28; G06Q 50/30; B65D 19/38

(52) U.S. Cl. CPC G06Q 50/28; B65D 19/38; G06Q 50/30; B65D 2203/10

(57) ABSTRACT

A pallet management system for managing pallets includes a central data processing arrangement and a plurality of pallets for transporting items and a plurality of pallet monitoring arrangements. At least one of the pallet monitoring arrangements is arranged on each of the pallets. Each of the pallet monitoring arrangements includes a locating unit for at least intermittently locating the respective pallet and a communication unit for at least intermittently communicating with the central data processing arrangement and transmitting location data of the respective locating unit thereto. Furthermore, the pallet management system has pallet logistics for transporting the pallets to their respective destination.

### CROSS-REFERENCES TO RELATED APPLICATIONS

This application claims the priority of German Patent Application, Serial No. DE 10 2020 203 207.6, filed Mar. 12, 2020, the content of which is incorporated herein by reference in its entirety as if fully set forth herein.

### FIELD OF THE INVENTION

The invention relates to a pallet management system for managing pallets. Furthermore, the invention is directed to a pallet, in particular for pallet management system of this type. The invention is further directed to a method for managing pallets by means of a pallet management system.

### BACKGROUND OF THE INVENTION

Pallets are widely known by obvious prior use and are used mainly for storage and transport of items. They have proven effective. The disadvantage is that pallets are often needed but are not in stock in a pool, such as a company pool. This may require time-consuming or cost-intensive procurement of new pallets.

### SUMMARY OF THE INVENTION

It is an object of the invention to create a pallet management system that is particularly user-friendly and efficient. A pallet that is particularly user-friendly and can be transported efficiently shall also be provided. Furthermore, a method shall be provided which is extremely user-friendly and efficient.

This object is achieved according to the invention by a pallet management system for managing pallets, having a central data processing arrangement, having a plurality of pallets for transporting items, having a plurality of pallet monitoring arrangements, wherein at least one of said pallet monitoring arrangements is arranged on each of said pallets, wherein each of said pallet monitoring arrangements comprises a locating unit for locating the respective pallet at least intermittently, and a communication unit for at least intermittently communicating with the central data processing arrangement and transmitting location data of the respective locating unit thereto, and having a pallet logistics for transporting the pallets to their respective destinations, a pallet, in particular for the pallet management system according to the invention, having a pallet monitoring arrangement for at least intermittently monitoring the respective pallet and/or at least one item arranged thereon, and a method for managing pallets by means of a pallet management system, comprising the steps of at least intermittently locating each pallet by means of a locating unit of at least one pallet monitoring arrangement arranged thereon, at least intermittently communicating with a central data processing arrangement by means of a communication unit of the respective pallet monitoring arrangement and transmitting location data of the respective locating unit thereto, and transporting the pallets to their respective destinations by means of a pallet logistics. The core of the invention is a pallet at which at least one pallet monitoring arrangement is arranged, directly or indirectly. The pallet monitoring arrangement permits intermittent or continuous monitoring of the respective pallet and thus also preferably of the at least one item arranged thereon, provided that the latter is loaded. Corresponding monitoring data or signals can be transmitted from the respective pallet monitoring arrangement to the central data processing arrangement, which is capable of processing the received monitoring data of the respective pallet.

The pallets constitute transport aids. It is convenient if at least one item, preferably a plurality of items, for example identical or different items, can be arranged on each pallet. It is advantageous if each pallet for this purpose has a carrying surface for carrying at least one item. Each pallet advantageously has a supporting surface for supporting it with respect to a base, such as a floor or a loading surface. Their form, shape and size may be arbitrary. The pallets may be identical or different. It is convenient for reasons of space if identical pallets can be stacked.

Favourably, each pallet can be displaced by means of an industrial truck. For this purpose, it preferably has at least one recess for engagement of the industrial truck, for example by a fork or tines thereof. Preferably, each pallet comprises at least two skids.

Each pallet is preferably made of wood, plastic, cardboard and/or metal. The pallet is designed as a single-use or reusable pallet.

Each pallet monitoring arrangement is self-sufficient, for example. Favourably, each pallet monitoring arrangement is designed as a sensor box. It is convenient if each pallet monitoring arrangement comprises a protective housing.

Each pallet monitoring arrangement is arranged, for example, in a form-fit, force-fit and/or materially bonded manner on the respective pallet, detachably or non-detachably. It is advantageous if each pallet monitoring arrangement can be retroactively arranged at the respective pallet.

It is convenient if each pallet monitoring arrangement has a computing unit/microprocessor, a data memory, such as fixed-value memory or random-access memory, and/or a clock, such as a real-time clock. The computing unit preferably includes evaluation electronics.

It is advantageous if the communication link between each communication unit/pallet and the central data processing arrangement is bidirectional. It is convenient if the communication link between each communication unit and the central data processing arrangement is wireless.

Each locating unit comprises, for example, a GPS (Global Positioning System) module. It is capable of determining a position and generating corresponding instantaneous position data that is representative of the current location of the locating unit or pallet. Continuous locating results in the most accurate and continuous position determination possible. A discontinuous position determination requires extremely little electrical energy. For example, the positioning can then be interval-controlled and/or specifically triggered.

Each communication unit preferably comprises a transmitter for the communication with the central data processing arrangement. It is convenient if it also has a receiver for the communication with the central data processing arrangement. Each communication unit is capable of transmitting at least position data of the pallet monitoring arrangement to the central data processing arrangement. Each communication unit is preferably also able to receive data from the central data processing arrangement or to receive queries.

It is expedient if each communication unit operates with radio, such as Bluetooth or mobile radio, infrared or the like. Advantageously, each communication unit has a radio module, such as GSM (Global System for Mobile Communications) module, GPRS (General Packet Radio Service) module and/or UMTS (Universal Mobile Telecommunications System) module, and/or WAN (Wide Area Network) module. It is advantageous if each communication unit is capable of communicating on its own. Alternatively, each communication unit is preferably part of a transmitter-receiver unit and designed, for example, as an RFID transponder which is capable of interacting with an RFID reading device. RFID reading devices are then located, for example, at user entrances and/or exits and/or at pallet logistics vehicles.

Each pallet monitoring arrangement is designed as a telematics arrangement, for example.

It is expedient if the central data processing arrangement comprises a receiver for the communication with the respective pallet monitoring arrangement. Alternatively, a receiver is assigned thereto. Preferably, it also comprises a transmitter for the communication with the respective/each pallet monitoring arrangement.

The central data processing arrangement is preferably electrical, in particular electronic. It is preferably capable of processing data from the pallet monitoring arrangements and advantageously of obtaining information.

The central data processing arrangement preferably comprises a data processing computer and is preferably capable of planning and/or controlling transports. It constitutes a pallet logistics or management arrangement and is advantageously stationary and spatially remote from the pallets.

The central data processing arrangement is capable, for example, of assigning received data to the respective pallet monitoring arrangement. It is convenient if this is done automatically, for example via a link. Each pallet monitoring arrangement is preferably uniquely identifiable in the network and/or preferably also separately addressable.

It is possible, for example, for the central data processing arrangement to receive or output an alarm from the respective pallet monitoring unit in the event of a detected deviation from target values.

The pallet is intelligent. It is a smart pallet.

The pallet logistics is able to transport the pallets. In particular, it is also capable of distributing or delivering empty and/or loaded pallets. The pallet logistics for transporting empty and/or loaded pallets is composed of, for example, at least one forwarding company and/or at least one courier, preferably by a plurality of forwarding companies and/or couriers. The pallets are transported, for example, by rail, motor vehicle, airplane, cargo bike or ship. It is expedient if different units of the pallet logistics perform the transport of empty pallets and loaded pallets.

Further advantageous embodiments of the invention are given.

The at least one energy source for at least intermittent energy supply is designed, for example, as a battery, rechargeable battery, solar panel, fuel cell and/or motion generator. It is convenient if the at least one energy source temporarily or continuously provides an energy supply for the respective pallet monitoring arrangement. Advantageously, the at least one energy source is an internal energy source. Alternatively, it is an external energy source.

The embodiment configured such that each of the pallet monitoring arrangements comprises an identifier for identifying the respective pallet enables unique identification of the pallet monitoring arrangement or respective pallet in the pallet management system. Different pallet monitoring arrangements or pallets preferably have different identifiers. They can thus be kept apart or distinguished from one another.

The pallet monitoring unit for at least intermittently monitoring the respective pallet and/or at least one item arranged thereon is, for example, capable of detecting physical and/or chemical properties, for example qualitatively or quantitatively as a measured value. It is a technical component and preferably comprises, for example, at least one sensor, such as a temperature sensor, motion sensor, acceleration sensor, weight sensor/pressure sensor, load history sensor, humidity sensor, gas sensor for detecting a gaseous substance, and/or alignment sensor, such as in the form of a spirit level. Alternatively, it is a camera. It is convenient if the pallet monitoring unit is active or passive. Preferably, the pallet monitoring unit is capable of generating a corresponding electrical signal or quantity as a measure of the respective property, condition, state and/or environment, which is conveniently further processable. Different environmental conditions, state conditions and/or changes are detectable. The associated communication unit is preferably capable of transmitting the corresponding electrical signal to the central data processing arrangement.

It is expedient if each pallet monitoring unit is assigned an activation unit for activating the respective pallet monitoring arrangement. Preferably, the activation unit is permanently in operation in order to be able to react to occurring events. A pallet monitoring arrangement of this type requires extremely little electrical energy when in use. The pallet monitoring arrangement is thus capable of assuming a deep sleep mode and, if necessary, being awakened by the respective activation unit.

For example, the central data processing arrangement is capable of detecting a relevant event, such as the start and/or end of a transport, via the respective locating unit and/or pallet monitoring unit.

According to the invention, each pallet monitoring arrangement is capable of determining an instantaneous (functional) state, such as damaged or undamaged, of the respective pallet. In particular, it is capable of determining, if applicable, whether the respective pallet has been improperly handled and has at least one damage. For example, each pallet monitoring arrangement is capable of determining whether the respective pallet has fallen, such as dropped, and/or been bumped, such as been run into. Preferably, each pallet monitoring arrangement is capable of determining where, at what angle, and/or with which intensity a corresponding force has been applied to the respective pallet. Advantageously, the pallet monitoring arrangement utilizes the pallet monitoring unit, such as a motion sensor, acceleration sensor and/or alignment sensor thereof, of the respective pallet for this purpose. For example, the motion sensor and/or acceleration sensor is/are capable of determining how much or fast the respective pallet has been moved or accelerated and the severity of the damage to the respective pallet. For example, the alignment sensor is capable of determining where damage has occurred to the respective pallet and how this pallet is currently aligned, such as tilted.

It is expedient if the central data processing arrangement receives corresponding damage information about a damage of the respective pallet, preferably via the communication unit of the respective pallet. Each pallet monitoring arrangement and/or central data processing arrangement is/are preferably capable of assessing the extent to which the respective pallet is damaged after being subjected to a corresponding force, or whether replacement thereof is required. It is convenient if the central data processing arrangement initiates a replacement of the damaged pallet, if necessary. It is advantageous if the pallet monitoring arrangement and/or central data processing arrangement is/are capable of storing information on damage to the respective pallet. This information can also be read out later, for example. It is thus possible, for example, to assign damage to a pallet to a time of damage, a location of damage and/or a person responsible for it. Advantageously, far-reaching optimizations are possible in this way, in particular for insurance companies, pallet suppliers and/or pallet owners or the like.

The pallet management system configured such that the central data processing arrangement knows a current employment state of each of the pallets is extremely efficient. Preferably, a distinction is made between at least the two states “store” and “tour”. The central data processing arrangement knows, for example, which pallet is currently free or stored. Preferably, it knows which pallet is currently in use, such as on a tour. The storage of the pallets is improved. Optimized route planning and intelligent control of transports is possible. A reduction in costs is achievable.

The embodiment in which the central data processing arrangement knows when each of the transported pallets arrives at its respective destination is particularly user-friendly. It is thus possible to prepare for the arrival of the respective pallet(s). The quality of service can thus be decisively increased for the user(s).

The pallet management system configured such that the central data processing arrangement is capable of matching a supply of the free pallets and a demand for a transport of the pallets is extremely economical. Unnecessary transports or journeys can preferably be avoided. Transport chains can be optimized. A material flow is thus improved. A particularly good capacity utilization can be achieved.

The pallet management system configured such that users are able to order free pallets for a transport to their respective destination via the central data processing arrangement is particularly user-friendly. It is convenient if each user is able to access the central data processing arrangement, for example via a computer, such as a smartphone, tablet computer, laptop computer or the like. In this regard, the user is preferably spatially remote from the central data processing arrangement. He is, for example, a recipient or shipper of the pallet(s).

The embodiment in which the central data processing arrangement is capable of indicating to the pallet logistics ordered pallets and their respective destination is again extremely user-friendly.

According to the invention, the pallet logistics is capable of accepting a transport of at least one ordered pallet. The pallet logistics selects in particular those pallets for transport whose transport is particularly economical for it. If the transport would be uneconomical, the acceptance of a transport is omitted. For example, multiple units transport the pallet(s) to their destination.

The embodiment in which the users are able to see information about each of the pallets being momentarily transported and/or at least one item placed on it is again particularly user-friendly. The users receive, for example, information about the current position, an employment state, upcoming steps, steps that have been taken, a processing progress, an arrival time and/or information of the respective pallet monitoring unit of the respective pallet(s).

The embodiment in which the users are able to track each of the transported pallets is again particularly user-friendly.

The empty pallet logistics units of the pallet logistics which collect required empty pallets and transport them to users are preferably capable of transporting the empty pallets by means of transport vehicles. Empty pallets are understood to mean pallets that are currently empty or unloaded. The empty pallets are preferably currently free or available.

It is expedient if the transport of ordered loaded pallets takes place via item pallet logistics units of the pallet logistics. The item pallet logistics units are advantageously capable of transporting the loaded pallets by means of transport vehicles. Item pallets are understood to mean pallets that are currently loaded with at least one item.

The embodiment in which each of the pallets comprises an electronic pallet transfer logging unit for logging a respective transfer of the respective pallet is extremely user-friendly. Each pallet transfer logging unit is preferably at least intermittently in signal connection with the communication unit of the respective pallet. It is expedient if the central data processing arrangement receives corresponding pallet transfer information about a respective transfer of the respective pallet, preferably via the communication unit of the respective pallet. By means of the electronic pallet transfer logging unit, the pallet management system is, for example, capable of informing an owner of the respective pallet who is currently the possessor of the respective pallet and/or where or with whom it is currently located. It is thus preferably capable of detecting a change of possession of the respective pallet and informing the owner of the respective pallet thereof. This is particularly interesting, for example, if the transport of the respective pallet takes place via a plurality of empty pallet logistics units and/or item pallet logistics units. For this purpose, each pallet transfer logging unit is capable, for example, of receiving and processing external pallet transfer information. For example, it has an interface, a writing field, a reading unit and/or a memory for this purpose. Alternatively, it is capable of independently recognizing a transfer of the respective pallet.

It is convenient if the pallet transfer logging unit is part of the pallet monitoring arrangement of the respective pallet. Alternatively, the pallet transfer logging unit and pallet monitoring arrangement of the respective pallet are separate or independent of one another.

A pallet with an electronic pallet transfer logging unit may also constitute a separate invention.

Each electronic waybill unit according to the invention preferably contains information about the cargo placed on the respective pallet or the at least one transported item, if any. The information is preferably modifiable for each transport. It is convenient if each electronic waybill unit contains information about the place and/or day of issue of a waybill, the name and/or address of the sender, the name and/or address of the respective carrier, such as the respective empty pallet logistics unit/item pallet logistics unit, the place and/or day of takeover of the cargo and/or the place intended for delivery, the name and/or address of the recipient and/or any registration address, the usual designation of the type of cargo and/or the type of packaging, number, marks and/or numbers of the packages/items, the gross weight or otherwise stated quantity of the cargo, the agreed freight and/or charges incurred up to delivery and/or a note of freight payment, the amount of any cash on delivery to be collected on delivery of the cargo, instructions for customs and other official handling of the cargo and/or an agreement for carriage in open vehicle not covered by tarpaulins or on deck. It is advantageous if the waybill information stored on each electronic waybill unit is readable. For example, each electronic waybill unit has an interface, a reading area/viewing area and/or memory for this purpose. It is convenient if the electronic waybill can be read or viewed via an authorization or key. It is particularly preferred if special authorities, such as customs authorities and/or police authorities, have at least partial, preferably complete, access to the respective electronic waybill, for example at a border and/or for a check.

It is expedient if the electronic waybill unit is part of the pallet monitoring arrangement of the respective pallet. Alternatively, the electronic waybill unit and pallet monitoring arrangement of the respective pallet are separate or independent of one another.

A pallet with an electronic waybill unit may also constitute a separate invention.

The pallet management system and pallet according to the invention, as well as the method for managing pallets according to the invention, allow overcoming the conventional exchange system between pallet owners/providers and a closed pallet pool which is usable with pre-determined transport volumes or pallet quotas. Such known pallet pools are closed, rigid and very expensive to use.

The invention preferably provides a “pay per use” or “pay for use” offer that fits into an open network of transport/logistics offers on the one hand and completely new, flexible or cost-effective methods/procedures of procuring the pallet(s) for at least one upcoming transport on the other hand.

The “pay per use” offer allows fair and easy pallet use. A purchase of pallets is preferably obsolete for the user. Likewise, balancing, especially for the user, is preferably obsolete. The conclusion of an insurance is preferably void for the user. Quota purchases are also preferably obsolete for the user.

The invention also favourably eliminates the need to be tied to specific transport or logistics service providers/units or their networks. Agreements with transport or logistics companies/units are preferably obsolete. A de-mocratization of the market is thus possible. Advantageously, transport and logistics platforms are thus freely available. For each individual pallet use, a functional or service scope can preferably be determined by the user or customer. Since the pallet is preferably capable of collecting data or information, a financing share is possible or determinable. As a standardized or non-standardized load carrying device, the pallet is purely a means of transport/logistics with a self-determined storage or transport function.

An intelligent pallet with the pallet management system preferably enables a customer/user determined or optimized transport chain. A shipment or a transport preferably runs through one hand or through many hands, favourably through/aided by artificial intelligence and/or self-selection by a user or customer. It is convenient if the user or customer is able to choose an individualized transport service, especially with regard to type, scope and/or consideration of personal preferences, such as environmental aspects, means of transport (such as CO₂ -neutral, hydrogen-powered, with environmental certificate), costs, transport speed, such as express, and/or package insert or the like.

The pallet management system according to the invention preferably serves as a platform with regard to transport or logistics requirements. Transport or logistics providers/units receive, for example, a transport or logistics demand network via the pallet management system, on the basis of which their supply network can be adapted, in particular individually, quickly and/or flexibly. It is expedient if artificial intelligence helps to efficiently bring together or link the needs and the supply.

An intelligent pallet makes this possible above all because process ownership is directly traceable. The process is preferably controllable. Preferably, the sovereignty over a logistics or transport chain lies with the user or customer. In particular, the pool regulates the condition of the pallets, a termination of an unfair exchange and/or quality according to customer requirements.

This allows efficiency gains to be achieved, for example. Unnecessary transports, for example, can be minimized. Unnecessary downtimes of pallets can be minimized, for example. There are preferred incentives for the pallet to be permanently in use. Predictions about load carrier usage are preferably possible. A variety of possible market-compliant regulation mechanisms regarding supply and demand for transport or logistics services/units are preferably possible due to previously unknown data or information. Independent third parties or empty pallet logistics units preferably provide for a transport of the load carriers or pallets to the customers or users and for a pallet supply on the basis of a service compensation.

It is expedient if the pallet management system allows, influences, or uses process monitoring, for example, with respect to temperature, hygiene, selected user(s), hazardous material transport(s), valuable material transport(s), emission monitoring, motion monitoring (such as shock), contamination monitoring (such as with/by liquids, gases, solids), spill protection, overload protection, access protection, protection zone(s), avoidance of defined locations, concentration and protection of a composition, protection and access times, evaluations, and/or meta-analyses.

It is advantageous if the pallet management system has an influence on and/or monitors a sale, such as a sales outlet or point of sale, and/or uses corresponding information, for example regarding product/item, place, promotion/special offer and/or price.

With regard to the product, for example, it is possible to determine or monitor what has been produced, how and/or when. Alternatively or additionally, it can be monitored or determined who has produced and/or which ingredient(s) are contained in the product. It is useful if a monitoring network is present at/on the pallet to control removals of the product/products and/or additions.

With regard to location, for example, it is possible to determine or monitor the location of the product/item in a store, its availability, purchase quantity/s, purchase time/s, purchase person/s, customer group/s (Bluetooth, etc.) and/or customer contact/s.

In terms of promotion/special offer, it is possible, for example, to generate flashes, sounds and/or smells and/or otherwise attract the customer’s attention, offer promotional merchandise and/or carry out sales promotions.

With regard to price, it is possible, for example, to change or generate prices for different customers, prices for different quantities, prices at different locations, prices at different times, prices at random, prices in case of shortage and/or prices depending on the inflow of goods.

For example, the pallet management system is able to monitor and/or influence a disposal of the product and/or pallet. For example, information on disposal options for the product/pallet, feedback on a successful disposal, feedback on recycling or incineration and/or credits are possible.

It is expedient if the pallet management system is able to monitor or influence rental options of the product and/or pallet. These concern, for example, a check for availability, ordering, an inflow, whereabouts, a loading, a check, a start, various transfers, start-up, information about location/ownership, arrival, transfer of risk, acceptance, deliveries, whereabouts and/or notice of availability.

It is advantageous if the pallet management system monitors or influences a process ownership of the product and/or the pallet. This can concern, for example, a loading, an information, an unloading, a notice of availability, a securing, a start, a growth and/or a maturity.

Advantageously, the pallet management system is able to use or control a billing system. For example, documentation takes place in doing so. For example, it is documented who has ordered, what has been ordered, where it has been delivered, with whom a transport has taken place, for what a transport has taken place, from what has been ordered/transported, and/or via whom/what. It is expedient if access is also possible for official channels, such as customs, tax, levy systems. It is convenient if a blockchain, license plate/s, ID systems, tokens, and/or something else unique is used for the billing system. Advantageously, a consumption of resources, in particular in terms of location, material, time and/or space, is taken into account. It is convenient if a check is made with respect to forecast residual usage, misuse, movement/s, time usage, kilometers, and/or condition of the pallet.

Advantageously, the pallet management system uses a central control and feedback system. It is convenient if the latter is connected to an IT system. For example, the pallet management system uses decentralized control and feedback system. It is advantageous if a connection to cloud systems is possible and/or virtual agents are used.

It is expedient if the pallet management system or the pallets is/are able to perform an over-the-air update. Preferably, at least one corresponding (radio) interface is provided for this purpose, for example at each pallet.

Advantageously, the pallets are integrated in an ad hoc network, which is preferably a radio network. It is advantageous if the pallets are able to communicate with each other. Preferably, an autonomous search for at least one other pallet and a communication/information exchange between them is possible. Communication to the outside is thus preferably possible if, for example, only one pallet, for example in a means of transport such as a commercial vehicle or container, or warehouse, has contact with the outside and passes on information for the other pallets.

The pallets are advantageously able to use low energy mesh or Bluetooth mesh, in particular for communication. It is advantageous if the pallets can be connected to a radio network, in particular a meshed one, preferably by means of Bluetooth. A higher-level radio network is thus not necessary for communication. This is particularly advantageous in means of transport or warehouses.

It is useful if the pallets are able to identify persons, robots, transport mechanisms or the like with a suitable device, such as Bluetooth-capable device. It is advantageous if a transfer of risk and/or a next process step can be documented in this way.

It is advantageous if, by encrypting the communication of the pallets with each other and/or with the central data processing arrangement, access by unauthorized third parties can be prevented and/or unlocked for authorized third parties, such as customs, police or the like.

The pallet management system or the pallets preferably use(s) a blockchain as a decentralized protocol for transactions between parties. It is expedient if every change can be recorded transparently. It is advantageous if the pallets are thus uniquely identifiable. Advantageously, a non-manipulable documentation, e.g. of the goods carrier and/or the goods, the origin, the producer and/or the stations is thus possible.

Favourably, in connection with the localization, in particular of the pallets, which is possible in a variety of ways, via a network of all standards, preferably including satellites, preferably plus mesh technologies, favourably based on Bluetooth, preferably also in warehouses/buildings and/or means of transport, such as containers, a new level of localization of the pallets can be achieved.

An essential component is preferably the energy reduction of the pallets due to logical protocols, so that, for example, if the parameters do not change, their transmission functions can be reduced and a favourable or advantageous/important moment can be waited for.

It is expedient if the pallets are able to participate in the Internet of Things. Advantageously, each pallet includes at least one suitable (radio) interface for this purpose and is thus able to participate in a data exchange of things. For example, an object such as a refrigerator, a device and/or building is capable of communicating a delivery or placement requirement, in particular to the data processing arrangement. It is convenient if at least one corresponding suitable pallet with at least one such available or needed item is able to answer then. By means of linkage/s of messages, at least one logistics process can preferably be initiated and processed in an optimized manner, in particular independently, if there is a corresponding fit/suitability. It is expedient if, by means of appropriate logic or linking, for example by AI, such a process can be initiated and executed independently in a resource-saving and time-saving manner or in accordance with customer requirements or preferences.

The features of the pallet management system also relate to preferred further embodiments of the pallet, in particular for the pallet management system according to the invention, having a pallet monitoring arrangement for at least intermittently monitoring the respective pallet and/or at least one item arranged thereon. The features of the pallet management system also relate to preferred further embodiments of the method for managing pallets by means of a pallet management system, comprising the steps of at least intermittently locating each pallet by means of a locating unit of at least one pallet monitoring arrangement arranged thereon, at least intermittently communicating with a central data processing arrangement by means of a communication unit of the respective pallet monitoring arrangement and transmitting location data of the respective locating unit thereto, and transporting the pallets to their respective destinations by means of a pallet logistics.

In the following, a preferred embodiment of the invention is described by way of example with reference to the attached drawing.

### BRIEF DESCRIPTION OF THE DRAWING

FIG. 1 shows a perspective view of a pallet according to the invention,

FIG. 2 shows a schematic illustration of a pallet monitoring arrangement of the pallet shown in FIG. 1,

FIG. 3 shows a simplified representation which illustrates a communication between empty pallet logistics units and a central data processing arrangement for the transport of the pallet shown in FIG. 1,

FIG. 4 shows a simplified illustration which shows a communication between item pallet logistics units and the data processing arrangement for the transport of the pallet shown in FIG. 1, and

FIG. 5 shows a simplified flow chart of the pallet management method according to the invention for the transport of the pallets

### DESCRIPTION OF THE PREFERRED EMBODIMENTS

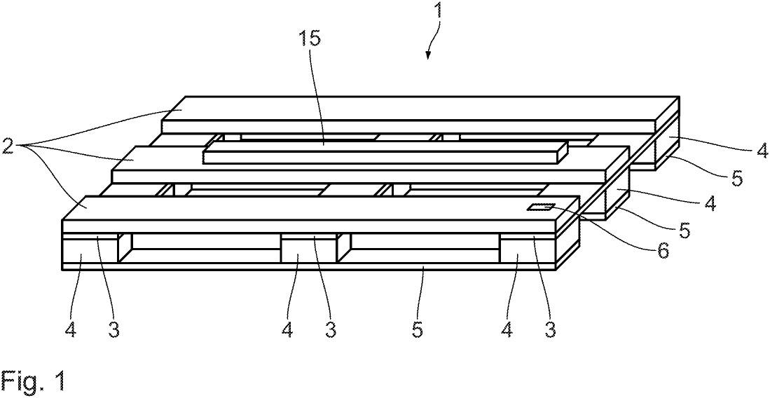

Referring first of all to FIG. 1, a pallet 1 shown there in its entirety comprises a plurality of cover boards 2 arranged side by side and extending parallel to one another, and three cross boards 3 extending perpendicularly to the cover boards 2 and below them. Two cross boards 3 extend edge-to-edge with respect to the pallet 1, while the other cross board 3 extends centrally therebetween. The cover boards 2 are attached to the top of the cross boards 3. Further, the pallet 1 has nine blocks 4 which support the cross boards 3. The cross boards 3 are arranged on the blocks 4. Four blocks 4 are located in corner regions of the pallet 1. Between each two blocks 4 arranged in the corner regions, one block 4 is arranged centrally on the edge side with respect to the pallet 1. There is one further block 4 in a central region of the pallet. Furthermore, the pallet 1 comprises three bottom boards 5 which extend perpendicularly to the cross boards 3 and are arranged below the blocks 4. The bottom boards 5 and the blocks 4 are in fixed connection with each other. Two bottom boards 5 extend alongside edges of the pallet 1, while one bottom board 5 extends centrally between them. The cover boards 2 form a carrying surface, while the bottom boards 5 form a standing surface. Other configurations of the pallet 1 are alternatively possible.

A pallet monitoring arrangement 6 is arranged fixedly or immovably at the pallet 1. The pallet monitoring arrangement 6 is arranged externally, for example, at a cover board 2, cross board 3, block 4 or bottom board 5. Alternatively, a corresponding recess is formed in the pallet 1 for the pallet monitoring arrangement 6, such as in the cover board 2, cross board 3, block 4 or bottom board 5.

According to FIG. 1, there is an item 15 to be transported on the pallet 1, which is locally fixed for transport relative to the pallet 1.

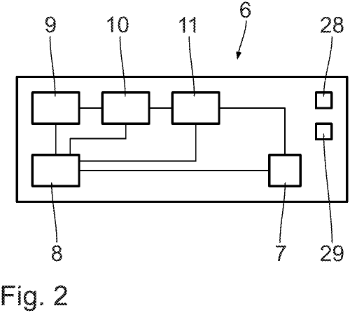

As FIG. 2 shows, the pallet monitoring arrangement 6 has a computing unit 7, a power source 8, a locating unit 9, a communication unit 10, and a pallet monitoring unit 11. The pallet monitoring arrangement 6 preferably further has an electronic pallet transfer logging unit 28 and an electronic waybill unit 29. The power source 8 is at least intermittently in direct or indirect electrical connection with the computing unit 7, the locating unit 9, the communication unit 10, the pallet monitoring unit 11, the electronic pallet transfer logging unit 28 and the electronic waybill unit 29, if any, and is capable of supplying electrical power, such as electricity, thereto. The locating unit 9, communication unit 10, pallet monitoring unit 11, electronic pallet transfer logging unit 28, and electronic waybill unit 29, if any, are in direct or indirect signal connection with the computing unit 7 to provide corresponding signals thereto and/or to receive signals therefrom. The locating unit 9, pallet monitoring unit 11, and pallet transfer logging unit 28, if present, are in direct or indirect signal connection with the communication unit 10. The communication unit 10 receives corresponding signals from these. It is convenient if the locating unit 9, communication unit 10, electronic pallet monitoring unit 11, pallet transfer logging unit 28, electronic waybill unit 29, power source 8, computing unit 7 and/or a memory, if any, are arranged on at least one printed circuit board.

Alternative wiring arrangements are possible. For example, the locating unit 9 and the communication unit 10 as well as the pallet monitoring unit 11 are at least intermittently in signal connection only with the computing unit 7, which in turn is at least intermittently in electrically conductive connection only with the power source 8.

Despite the described separation of the locating unit 9, communication unit 10, pallet monitoring unit 11, computing unit 7, electronic pallet transfer logging unit 28, electronic waybill unit 29 and energy source 8, these components do not have to be arranged or designed strictly separately from one another. They can all or in smaller groups together be arranged or, in particular, integrated at any desired location.

The pallet monitoring arrangement 6 is capable of communicating with a remote central data processing arrangement 12 via its communication unit 10. The central data processing arrangement 12 is capable of receiving signals/data from the pallet monitoring arrangement 6 and thus also from the pallet 1. These data include current position data from the locating unit 9 and instantaneous data, such as condition data and/or environmental data, from the pallet monitoring unit 11.

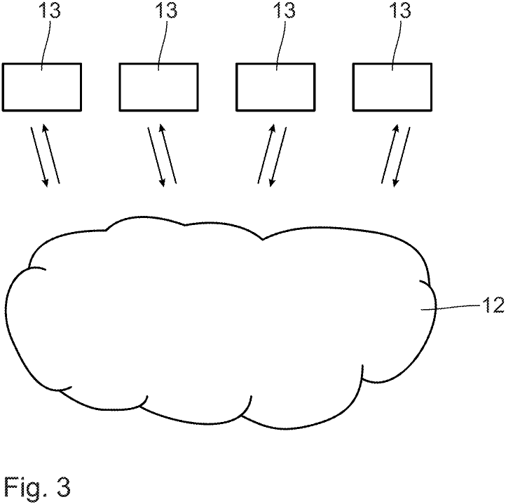

The central data processing arrangement 12 is capable of processing these data. In particular, it is capable of processing data from a plurality of pallets 1 or pallet monitoring arrangements 6, such as preferably at least 5, preferably at least 100, preferably at least 1,000, pallets 1 or pallet monitoring arrangements 6. It is also capable of communicating with empty pallet logistics units 13 which are interested in transporting empty pallets 1 (FIG. 3). In particular, the central data processing arrangement 12 is capable of indicating to the empty pallet logistics units 13 that there are currently empty pallets 1 and where they are currently located. It is also indicated to the empty pallet logistics units 13 which user(s) currently need empty pallets 1 or where these are needed. This way, it is likewise indicated to the empty pallet logistics units 13 that the empty pallets 1 are to be fetched from a first location, for example, and transported to the respective user who is located at a distance from the first location.

Each empty pallet logistics unit 13 is capable of accepting a corresponding offer to transport at least one empty pallet 1 to at least one user.

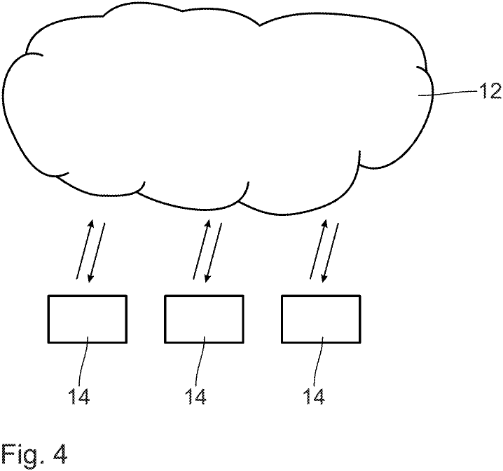

As shown in FIG. 4, the central data processing arrangement 12 is capable of communicating with item pallet logistics units 14 which are interested in transporting loaded pallets 1. The item pallet logistics units 14 are capable of seeing and, if necessary, accepting ordered or currently occurring transports.

Once a loaded pallet 1 is transported by an item pallet logistics unit 14, the user is able to view information from the corresponding pallet monitoring arrangement 6.

A software and the pallet management system are provided to a plurality of users. An interface of the software forms, for example, a graphical support for the visualization of empty pallets 1 and/or pallets 1 to be transported. Search functions are preferably possible. The pallet management system is, for example, a central system of a transport and logistics company which is responsible for the transport of pallets 1. Data can also be forwarded to a central system of users or pallet logistics 13, 14.

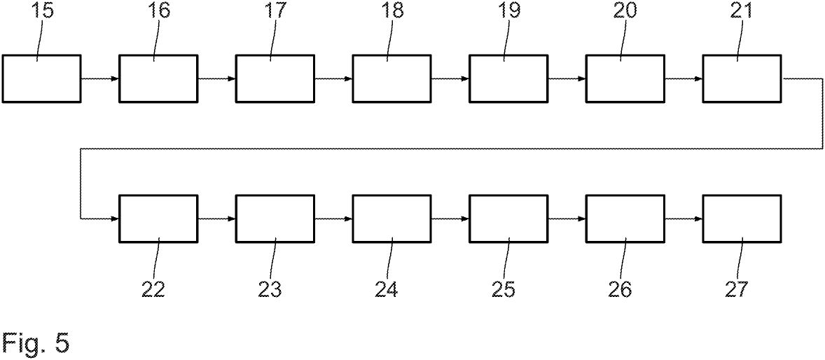

In the following, with reference to FIG. 5, the sequence of the method is explained with reference to a pallet 1 and a user for the sake of simplicity, although in practice there are a plurality of pallets 1 and a plurality of users. The pallet 1 is later loaded with an item 15. In practice, the pallet 1 may then also be loaded with a plurality of items 15.

In a first step 15, a registered user or customer announces a need for a pallet 1 and its transport to a destination with the central data processing arrangement 12.

Subsequently, in a next step 16, the user receives information about the transport of the pallet 1, such as cost, start and/or duration, from the data processing arrangement 12.

In a next step 17, the user is able to accept the offer with the central data processing arrangement 12 to help himself to the pool of free pallets 1.

Upon acceptance of the offer, a commissioned empty pallet logistics unit 13 transports the empty pallet 1 to the user at a next step 18. A plurality of empty pallet logistics units 13 may take over partial distances.

The pallet 1 informs the central data processing arrangement 12 in a next step 19, for example based on the locating unit 9, when it has arrived at the user.

At a next step 20, the central data processing arrangement 12 knows when the pallet monitoring unit 11 is loaded with at least one item 15 and ready for pickup based on the pallet monitoring unit 11.

The central data processing arrangement 12 then, at a next step 21, indicates to registered item pallet logistics units 14 that a user’s transport order exists.

In a next step 22, an item pallet logistics unit 14 is capable of accepting the transport order.

The central data processing arrangement 12 then receives, if necessary in a next step 23, information, for example from the pallet monitoring arrangement 6, when the item pallet logistics unit 14 has taken over the pallet 1 and is transporting it to the desired destination. The user is also informed accordingly. He is informed by the pallet monitoring arrangement 6 about the current location of the pallet 1. He also receives further information about the pallet 1 and thus also about the loaded item(s) 15 originating from the pallet monitoring unit 11, such as a current temperature value, humidity value and/or concentration value of an environment of the pallet 1 or the item 15, a current motion value, acceleration value and/or alignment value of the pallet 1 or the item 15, a loading history value of the pallet 1 and/or a weight value/pressure value of the item 15.

To this end, the central data processing arrangement 12 sends corresponding information to the user in a next step 24. This information is preferably repeatedly communicated to the user to keep the user informed.

Subsequently, in a next step 25, the user is informed via the central data processing arrangement 12 when the pallet 1 has arrived at its desired destination. This information originates, for example, from the locating unit 9 and/or the pallet monitoring unit 11. Further information, in particular about the condition of the item 15, which originate from the pallet monitoring unit 11 are also communicated to the user by the central data processing arrangement 12. The recipient also receives corresponding information from the central data processing arrangement 12.

Subsequently, in a next step 26, the central data processing arrangement 12 is again informed that the pallet 1 is free again. This information originates, for example, from the pallet monitoring unit 11.

In a next step 27, the central data processing arrangement 12 again indicates to empty pallet logistics units 13 that an empty pallet 1 is present and ready for collection. The process virtually starts again from the beginning.

In the claims:

1. A pallet management system for managing pallets , the pallet management system comprising:
a) having a central data processing arrangement;
a plurality of pallets for transporting items;
c) having a plurality of pallet monitoring arrangements , wherein at least one of said pallet monitoring arrangements is arranged on each of said pallets , wherein each of said pallet monitoring arrangements comprises
a locating unit (9) for locating the respective pallet at least intermittently, and
a communication unit for at least intermittently com-municating with the central data processing arrangement and transmitting location data of the respective locating unit thereto; and
a pallet logistics for transporting the pallets to their respective destinations.

2. The pallet management system according to claim 1, wherein each of the pallet monitoring arrangements comprises at least one energy source for at least intermittent energy supply.

3. The pallet management system according to claim 1 , wherein each of the pallet monitoring arrangements comprises an identifier for identifying the respective pallet .

4. The pallet management system according to claim 1 , wherein each of the pallet monitoring arrangements comprises at least one of the group comprising a pallet monitoring unit for at least intermittently monitoring the respective pallet and at least one item arranged thereon.

5. The pallet management system according to claim 1 , wherein each of the pallet monitoring arrangements is configured to detect at least partial damage to the respective pallet .

6. The pallet management system according to claim 1 , wherein the central data processing arrangement knows a current employment state of each of the pallets .

7. The pallet management system according to claim 1 , wherein the central data processing arrangement knows when each of the transported pallets arrives at its respective destination.

8. The pallet management system according to claim 1 , wherein the central data processing arrangement is configured to match a supply of the free pallets and a demand for a transport of the pallets .

9. The pallet management system according to claim 1 , wherein users are able to order free pallets for a transport to their respective destination via the central data processing arrangement .

10. The pallet management system according to claim 9, wherein the central data processing arrangement is configured to indicate to the pallet logistics ordered pallets and their respective destination.

11. The pallet management system according to claim 10, wherein the pallet logistics is configured to accept a transport of at least one ordered pallet .

12. The pallet management system according to claim 9 , wherein the users are able to see information about at least one of the group comprising each of the pallets being momentarily transported and at least one item placed on the pallets.

13. The pallet management system according to claim 9 , wherein the users are able to track each of the transported pallets .

14. The pallet management system according to claim 1 , wherein empty pallet logistics units of the pallet logistics collect required empty pallets and transport them to users.

15. The pallet management system according to claim 1 , wherein each of the pallets comprises an electronic pallet transfer logging unit for logging a respective transfer of the respective pallet .

16. The pallet management system according to claim 1 , wherein each of the pallets comprises an electronic waybill unit (29).

17. The pallet, comprising a pallet monitoring arrangement (2) for at least intermittently monitoring at least one of the group comprising the respective pallet and at least one item arranged thereon.

18. A method for managing pallets by means of a pallet management system, the method comprising the steps of
at least intermittently locating each pallet by means of a locating unit of at least one pallet monitoring arrangement arranged thereon,
at least intermittently communicating with a central data processing arrangement by means of a communication unit of the respective pallet monitoring arrangement (2) and transmitting location data of the respective locating unit thereto, and
transporting the pallets to their respective destinations by means of a pallet logistics .

19. The method according to claim 18, wherein empty pallets are indicated to empty pallet logistics units of the pallet logistics for transporting them to users.

20. The method according to claim 19, wherein ordered pallets are indicated to the pallet logistics for transporting them to their respective destination.

21. The method according to claim 18 , wherein each of the pallet monitoring arrangements transmits information about the respective pallet , as it is transported, to the central data processing arrangement .

22. The pallet according to claim 17, being a pallet for the pallet management system according to claim 1.
